(19) United States
(12) Patent Application Publication
(10) Pub. No.: US 2015/0137740 A1
(43) Pub. Date: May 21, 2015

(54) System and Method for Mobile Charging

(71) Applicant: Khalid Mike Allos, (US)

(72) Inventors: Khalid Mike Allos, Lakeside, CA (US); Layth Karana, Lakeside, CA (US); Zayed Zawaideh, Lakeside, CA (US)

(21) Appl. No.: 14/540,596

(22) Filed: Nov. 13, 2014

Related U.S. Application Data
(60) Provisional application No. 61/903,779, filed on Nov. 13, 2013.

(51) Int. Cl. H02J 7/00; B60L 11/18

(52) U.S. Cl. CPC H02J 7/0054; H02J 7/0042; B60L 11/1811; B60L 11/1822; H02J 2007/0059
USPC 320/107

(57) ABSTRACT

Provided is a mobile charging system, e.g., implemented on a movable cart, that can be easily wheeled or carried to a location of a vehicle. The mobile charging system can be used to not only jumpstart or booster battery, but also to fully charge the battery. In this way, the mobile charging system eliminates the need to transport the vehicle to a service facility.

### CROSS-REFERENCE TO RELATED APPLICATIONS

This application claims benefit of priority of U.S. provisional Patent Application Ser. No. 61/903,779, filed Nov. 13, 2013, entitled “Mobile Charger for 12 VDC Systems”, owned by the assignee of the present application and herein incorporated by reference in its entirety.

### BACKGROUND OF THE INVENTION

It is a common problem that automobile batteries discharge to the point where they are unable to start and automobiles engine, and this condition is commonly termed a “dead battery”. In order to charge the battery, the vehicle must be towed to a service facility. Complicating this is that most modem day vehicles require an adequate power source to deactivate the lock safety of the transmission park and neutral positions for the purpose of moving or towing the vehicle. If the battery is dead, not only will the car not start, but the same can no longer be moved or towed without risking serious damage to the automobile.

### SUMMARY

Present principles include a mobile charging system, e.g., implemented on a movable cart, that can be easily wheeled or carried to a location of a vehicle. In this way, the mobile charging system eliminates the need to transport the vehicle to a service facility. One of the main functionalities of certain implementations of present principles includes the ability to fully charge a dead or a discharged battery, allowing the vehicle to be started and driven. As a result the mobile charging system provides significant efficiencies for businesses that deal with automotive services such as mechanics shops, dealerships, body shops, auction yards, auto wrecking yards, and any businesses with large parking lots or multi level parking buildings.

In addition, the mobile charging system according to present principles may in some implementations enjoy a significant advantage over existing battery boosters. In particular, automobile manufacturers recommend charging the battery fully before driving the vehicle. In fact in many cases the same do not recommend driving the vehicle with a discharged battery after a jump start, because it may permanently damage electrical and electronic components.

Advantages of the invention may include one or more of the following. The mobile charging system can be easily wheeled to and throughout large parking lots and structures and between tight places. The mobile charging system may contain circuitry that protects itself and the vehicle electrical system from reverse polarity that may be potentially damaging and caused by human error. The mobile charging system may include an indicator, e.g., a green light indicator, to alert the operator when the system is interfaced correctly to the vehicle.

### BRIEF DESCRIPTION OF THE DRAWINGS

FIG. 1 illustrates an exemplary schematic diagram for one implementation of a mobile charging system according to present principles.

FIGS. 2A-2D illustrate a circuit which may be employed for an implementation of a mobile charging system according to present principles

### DETAILED DESCRIPTION

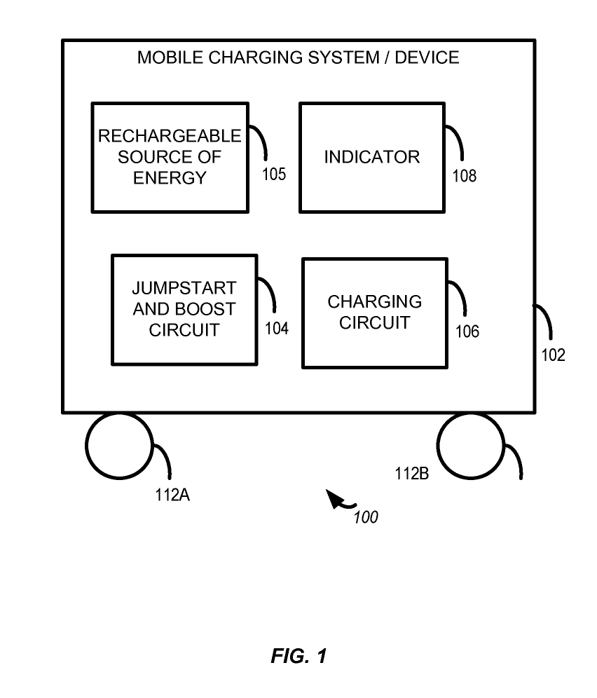

An exemplary mobile charging system or device 100 is illustrated in FIG. 1. The system 100 includes a housing 102 which may be carried or rolled on optional wheel assemblies 112A and 112B. In many cases three or four wheel assemblies will be included.

Coupled to the housing may be a rechargeable source of energy 105, which is in many cases a plurality of battery cells which may be charged, e.g., from a wall or other outlet source. The mobile charging system further includes an indicator 108 to indicate to the user various aspects, including whether the system is ready to charge a dead or insufficiently charged battery, whether the device has been hooked up properly to the dead or insufficiently charged battery, or the like.

The mobile charging system 100 further includes at least two types of circuits, including a jump start and boost circuit 104, and the charging circuit 106. The jumpstart and boost circuit 104 may be employed to provide an immediate jumpstart to a battery. However, in many cases such jump starts are harmful to the battery, and for this reason the charging circuit 106 may be employed to fully charge a battery in a rapid manner. By fully charging the battery, the deleterious effects of the jumpstart procedure are avoided.

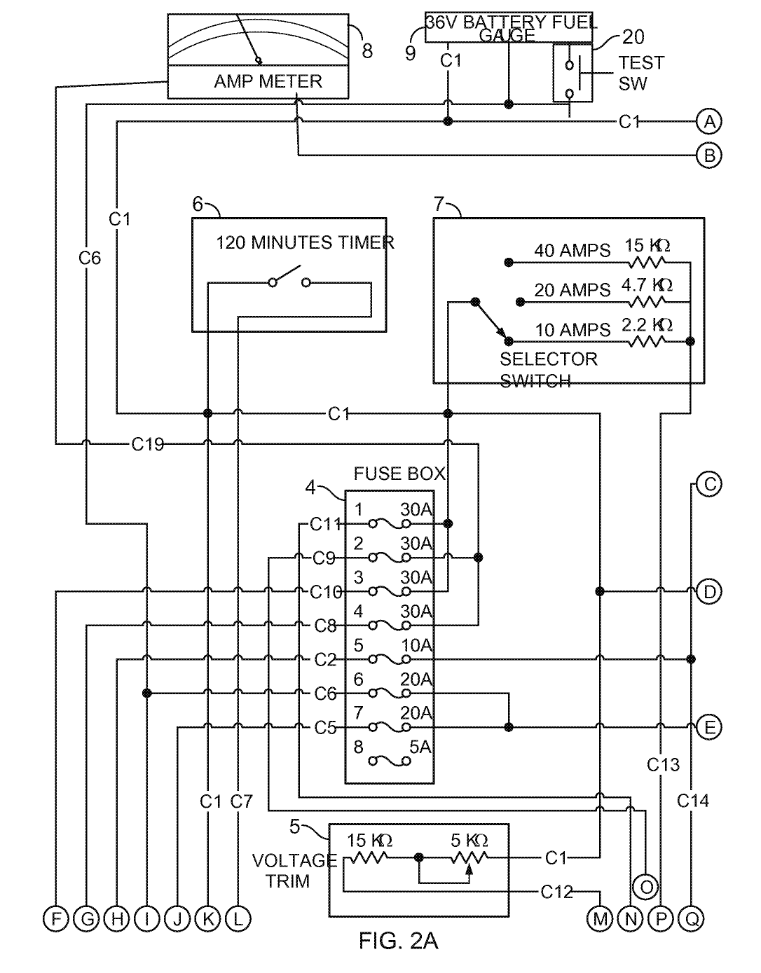

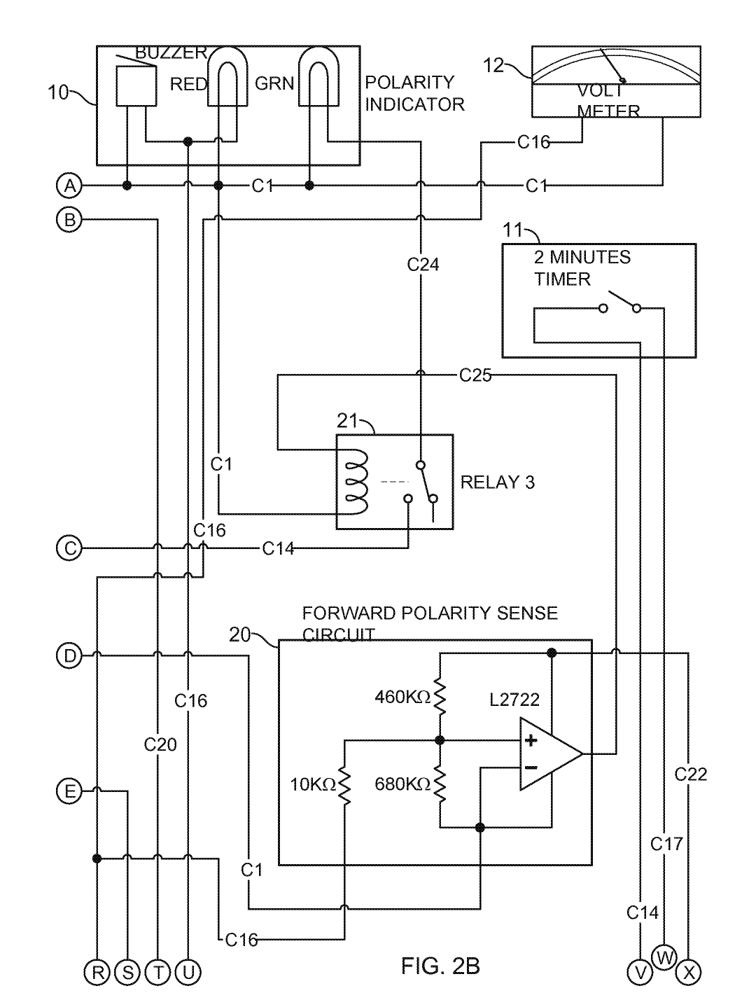

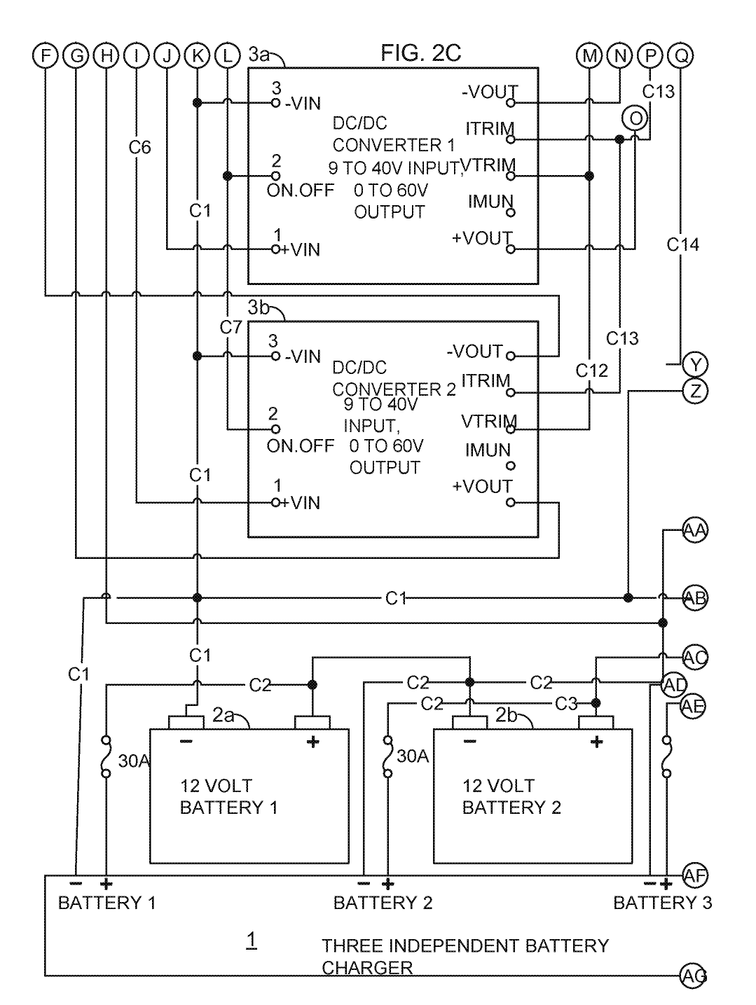

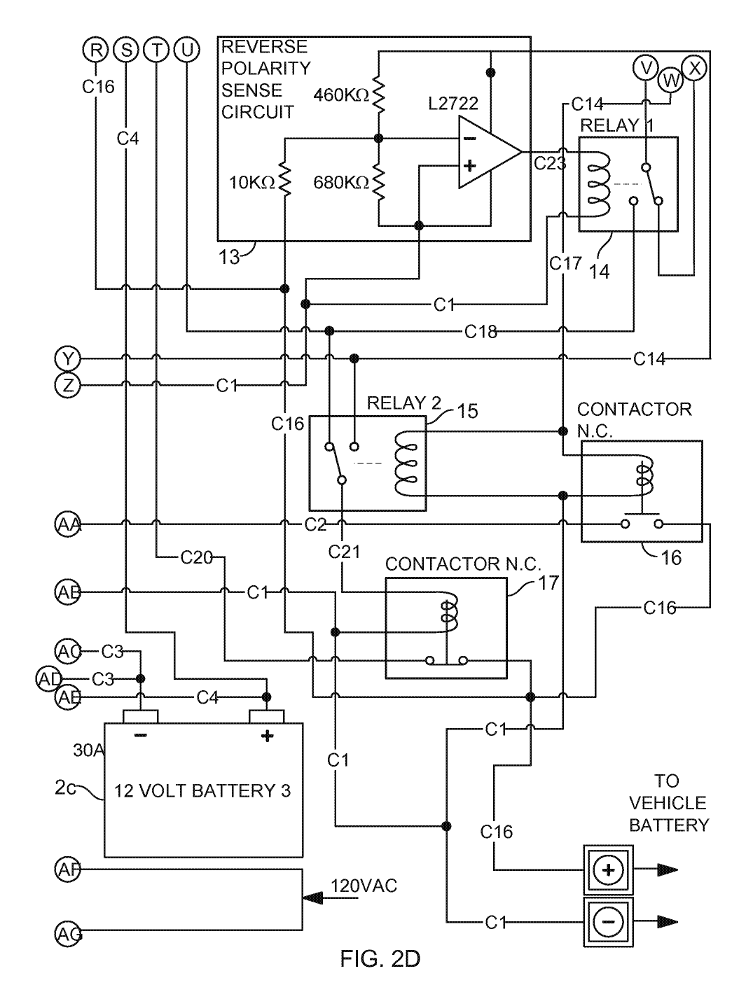

While clearly present principles are more general than a specific implementation, for purposes of discussion, a specific implementation is illustrated by the circuit diagram shown in FIG. 2A-2D. In particular, it is noted that variations in values of voltages and currents may be employed in given implementations, and that certain circuit components may be combined in various ways or implemented with different circuitry, including microprocessors. Accordingly, equivalent circuit configurations are also intended to be encompassed by the scope of present principles.

Table I below provides a list of circuits within FIG. 1 and exemplary voltage values.

TABLE I
C1 = 0.0 volts, common ground. battery 1 negative, 0.0 volts reference
to all other circuits.
C2 = 12 V, Battery 1 Positive, series connection to battery 2 negative,
12 V power source for MCS internal components.
C3 = 24 V, battery 2 positive, series connection to battery 3 negative.
C4 = 36 V, battery 3 positive, 36 V power source for MCS charging
system components.
C5 = 36 V, Fuse No. 7 power source “+Vin” to component 3a.
C6 = 36 V, Fuse No. 6 power source “+Vin” to component 3b,
power source for battery fuel gauge.
C7 = Charge cycle off = ON = 0.0 V
C8 = 13.8 to 14.3 VDC, charge cycle output to Fuse No. 4.
C9 = 13.8 to 14.3 VDC, charge cycle output to Fuse No. 2.
C10 = 0.0 V, charge output common ground to Fuse No. 3.
C11 = 0.0 V, charge output common ground to Fuse No. 1.
C12 = 1.5 V, voltage trim input
C13 = Output current trim (Itrim) input, Selector switch positions as
follows

10 amp = 0.44 V
20 amp = 0.78 V
40 amp = 1.46 V

C14 = 12.0 VDC, Fuse No. 5 output power source for MCS internal
components.
C15 = not used.
C16 = 2.0 to 14.3 VDC, vehicle battery input to MCS internal
components.
C17 = Boost cycle control, OFF = 0.0 V, ON = 12.0 VDC.
C18 = 0.0 V during boost or charge cycle, 12.0 V during reverse polarity
detection and enable.
C19 = 13.8 to 14.3 VDC charge cycle output from Fuse No. 2 and 4 to
Amp Meter.
C20 = 13.8 to 14.3 VDC charge cycle output from Amp Meter to N.C.
Contactor.
C21 = Boost cycle = 12.0 VDC, charge cycle = 0.0 V reverse
polarity detection = 12.0 V
C22 = 12.0 V during charging and boost cycle, 0.0 V during reverse
polarity condition.
C23 = 12.0 V during reverse polarity condition only, others 0.0 V.
C24 = 12.0 V during forward polarity condition only, others 0.0 V.
C25 = 12.0 V during forward polarity condition only, others 0.0 V.

Table II provides an exemplary list of components.

TABLE II
1 = 12 V three bank battery charger (Delta Volt), professional series
Model No. XXXX
2a, 2b, 2c = each 12 V Lead Acid Battery, AC Delco No. XXXX or
equivalent.
3a, 3b = DC/DC converter by SynQor, Inc. Part number
NQ40W40QGV30NRC-G
4 = Fuse Box
5 = Voltage Trim
6 = 120 Minutes Timer Switch
7 = Selector Switch by Electroswitch Inc. part number 7108Z.
8 = Amp Meter, by Shurite, part number 7207Z
9 = 36 V Battery Fuel Gauge (Delta Volt Model No. BFG36V)
10 = Polarity indicator lights and buzzer.
11 = 2 Minute timer switch.
12 = Volt Meter, by shurite, part number 7108Z.
13 = Reverse polarity sense circuit
14 = Relay 1
15 = Relay 2
16 = Contactor N.O.
17 = Contactor N. C.
18 = Positive Output to vehicle
19 = Negative Output to vehicle
20 = Forward Polarity Sense Circuit
21 = Relay 3

a particular implementation, a greater or lesser number of circuits and components may be employed, and the type, structure, configuration, and values of components within may vary.

Referring to FIGS. 2A-2D, a mobile charging system may include apparatus to contain stored energy, e.g., in a chemical form, such as a series of batteries 2a, 2b, and 2c shown in the figure. In the figure, three 12 VDC batteries are connected in series to form a 36 VDC battery pack.

The batteries may be lead acid, absorption glass mat (AGM), lithium ion, or the equivalent, in their particular electrical specifications can vary. In one implementation, the mobile charging system may employ three deep cycle lead acid batteries with ampere hour ratings of 95 ampere-hours.

In order to ensure that the batteries are fully and equally charged, the mobile charging system may use a battery charger 1 with three independent and isolated charging banks that is connected to a 120 VAC source during the charging phase when the mobile charging system is not being used. When the 36 VDC battery pack is fully charged, charger 1 may be configured to automatically shut off and a green light may illuminate on battery fuel gauge 9 when the test switch 20 is pressed, indicating that the mobile charging system is ready to be used. Then the same can be disconnected from the 120 VAC source and rolled or carried to a location of a vehicle that has a dead or a discharged battery. The mobile charging system may be connected to the electrical system of that vehicle via battery cables 18 and 19 and clamped onto each terminal of a dead battery.

When a technician is physically connecting the mobile charging system to a vehicle with a discharged battery, two possible operational conditions may ensue.

Condition 1: the mobile charging system may be connected correctly when the positive cable 18 is connected to the vehicle battery positive post and the negative cable 19 connected to the vehicle battery negative post. This condition is referred to as a forward polarity connection.

Condition 2: on occasion, due to technician error, the mobile charging station may be connected incorrectly, e.g., when the positive cable 18 is connected to the vehicle battery negative post and the negative cable 19 is connected to the vehicle battery positive post. This condition referred to as a reverse polarity connection.

Operational descriptions of these two conditions are now described.

### Condition 1:

When the mobile charging system is correctly connected to a vehicle with a discharged battery, the green warning light 10 will illuminate, indicating proper connection. Component 18 with circuit C16 will have positive voltage and component 19 with circuit C1 will have negative voltage. C16 and C1 circuits are monitored by component 20 (forward polarity sense circuit), and this component includes three resistors with ratio values biased for low voltage detection. When circuit C16 voltage value is 2 or more volts more positive than circuit C1, the operational amplifier L2722 will conduct and switch its output circuit C25 to 12V positive to energize component 21 (Relay 3). When relay 3 N.O. (normally open) contacts are closed, 12V power from circuit C14 will connect with circuit C24 to turn green light on in component 10, indicating the correct and safe hook-up of the mobile charging system.

Properly hooked up, the mobile charging system in certain implementations provides two independent functions as follows.

### Function 1: Jump-Start and Boost

This function is commonly used in the automotive industry. The mobile charging system contains this feature because of convenience and necessity specifically in automotive repair facilities. The jump-start and boost functions can be activated with, e.g., a two-minute timer switch 11. The switch dial can be rotated manually clockwise and set up to a maximum time of 2 minutes (and thus other times are also possible). Once the switch is set to the desired time, then the dial may automatically rotate counter-clockwise and shuts off when it reaches 0.

When switch 11 is set, the internal electrical contacts are closed, and when switch 11 shuts off, the contacts are open. In this way, the mobile charging system allows a maximum of a 2 minute window for each intervals of boost function.

Component 11 receives 12V power from component 14 Relay N.C. (normally closed) contacts, from circuit C14 through circuit C22. When component 11 internal contacts are closed, 12V power is switched to circuit C17, energizing contactor 16 (Normally Open). Closing internal contacts results in a high current connection between circuit C2 and C16 that provides a direct connection between battery 2a and positive circuit C2 and vehicle battery positive post 18. This allows for the high current transfer needed to jump start a vehicle.

During the boost function, component 15 is also energized, closing internal contacts and transferring 12V power from C14 to C21, for the purpose of energizing contactor 17 N.C.to break open internal contacts that will disconnect circuit C20 from C16. Component 17 acts as an isolator between the boost function and charging function of the MCS. It is also energized during reverse polarity conditions.

### Function 2: Charging

Automotive battery boosters are very common in the industry and the same are used only to jump start vehicles, but they lack the ability to charge the vehicle battery. The mobile charging system according to present principles allows an on-board charging system, along with the boost capability described above. This feature is enabled only when the mobile charging system is connected correctly to a vehicle battery. The charging function utilizes the full 36 VDC power of the battery pack 2a, 2b and 2c. The output from battery 2c positive terminal goes through circuit C4 to fuse number 6 and 7. The 36V power output from Fuse No. 6 and 7 flows through circuit C5 and C6 to provide positive power input to component 3a and 3b.

### Description of Components 3a and 3b

Components 3A and 3B are DC/DC converters that are used to regulate output voltage and current. Each converter is capable of a maximum output current of 30 amps. The mobile charging system circuitry may in some cases limit each converter maximum output to 20 amps to prevent overheating.

In one implementation, the mobile charging system can charge a vehicle battery at a maximum rate of 40 amps. Therefore, component 3a and 3b may be connected in a parallel configuration and may share their inputs and outputs, resulting in a combined output maximum current rate of 40 amps, 20 amps from converter 3a and 20 amps from converter 3b. Both converters' output voltages may be regulated between 13.8 to 14.3 VDC.

### Charging Function Controls

The mobile charging system may contain in one implementation five primary components used to regulate the output voltage and current to properly recharge a discharged vehicle battery, and these are components 3a, 3b, 5, 6 and 7. Components 3a and 3b are as noted above, e.g., switching regulator DC to DC converters. In one specific implementation the same are identical in model and part numbers, with the same electrical characteristics and specifications. Because of their configuration, they share the same inputs and outputs and are connected (wired) in parallel; therefore, the shared output current will max out at 40 amperes.

### Turning ON Charge Feature

The charge cycle may be initiated by activating component 6 which is a 120 minute rotary timer that contains internal contacts. When the desired time is set, the contacts will close allowing circuit C1 to connect with C7, applying 0 volts to pin #2 for each DC/DC Converters 3a and 3b allowing the same to turn on or otherwise be enabled.

When components 3a and 3b are enabled, then current may flow through their pins numbered 1 for a positive VIN and Pin 2 for a negative VIN.

### Power Regulation

Component 3a and 3b power regulation is a voltage and current calibration and is accomplished as follows.

### Voltage Regulation

Using component 5 voltage trim (DC/DC converter input Pin No.6) to adjust output voltage between a minimum 13.8 volts to a maximum of 14.3 volts. This value is chosen as an ideal voltage range to recharge a battery. This component consists of one resistor and one potentiometer. It uses circuit C1 0.0 volts and circuit C12 that connects to Pin No. 6 of component 3a and 3b.

### Current Regulation

Using component 7 selector switch, DC/DC converter input Pin No.5 may be employed to set the desired current output of component 3a and 3b. This switch has three positions that represent the charging rate of the mobile charging system. These include a slow charge rate, e.g., 10 amperes, a medium charge rate, e.g., 20 amperes, and a fast charge rate of, e.g., 40 amperes. The slower the charge rate, the longer the time required to recharge a battery. The faster the charge rate, the shorter the time to recharge. It will be understood that other implementations may include more or fewer positions and selectable charging rates.

Component 7 is connected to C1 0.0 volts and includes three resistors with pre calculated values that create a desired output voltage drop to circuit C 13 that is connected to Pin 5 (Itrim) of component 3a and 3b.

### Output

The regulated voltage and current of component 3a and 3b is output using pin 4 for negative voltage through circuit C11 to fuse 1 and circuit ClO to fuse 3.

Output pin 8 is for positive voltage through circuit C9 to fuse 2 and circuit C8 to fuse 4.

These fuses are used to protect the output drivers of components 3a and 3b in the event of a reverse polarity condition due to technician error.

The negative output of fuse 1 and 3 is combined and connected to negative common circuit C1 that is equal to 0.0 volt. The positive output of fuse 2 and 4 is also combined and connected to circuit C19 that feeds component 8 Amp Meter for current measurement and display. Current flows through the meter to circuit C20 and then to component 17 contactor N.C. When component 17 is de-energized, current flows through it from circuit C20 to circuit C16 and then to component 18 to the vehicle battery.

Component 17 acts as an isolator between charging and boost cycles. As such, the same is de-energized during a charging cycle of the mobile charging system, and energized during jump start or “boost” function and during reverse polarity detection condition. During the charging cycle of the mobile charging system, the voltage output will vary between 13.8 to 14.3 volts, depending on the condition of the vehicle discharged battery.

### Condition 2: Reverse Polarity Connection

This condition occurs when a technician connects the mobile charging system cables components 18 and 19 in reverse order to the vehicle battery. This condition can create an electrical short or over load that causes damage to internal components of the mobile charging system. The amount of damage is relatively proportional to the condition of the vehicle battery and the amount of power it can deliver. The mobile charging system on board batteries also have a considerable amount of power and are capable of causing damage to vehicle electrical systems in the event that the boost cycle is energized.

During the reverse polarity condition, circuit C1 becomes positive in its polarity and circuit C16 becomes negative.

This reverse source of voltage originates from the vehicle battery. Component 13 is a reverse polarity sense circuit that uses circuit C1 and C16 for input signals. It also uses circuit C14 from fuse No.5 for a 12 voltpower source that originates from battery 2a.

The reverse polarity sense circuit 13 includes in one implementation three resistors with ratio values biased for low voltage, e.g., approximately negative 2 volts or greater at circuit C16. An operational amplifier L2722 may be configured as a voltage comparator. This component will output positive 12 volts through circuit C23 when its negative input is more negative than its positive input with approximately 2 volts or greater. This only occurs in reverse polarity connection to vehicle battery.

The reverse polarity sense circuit is designed and configured in this manner to have the ability to detect reverse polarity condition even if the vehicle battery is discharged from 12 volts to as low as 2 volts.

Once the reverse polarity sense circuit detects reverse polarity, it will conduct current and switch output circuit C23 to positive 12 volts energizing component 14 relay 1 that will result in the enabling of the reverse polarity protection feature of the mobile charging system, and the disabling of the boost cycle power source to component 11.

### Components and Circuits States During Reverse Polarity Enable

### Component 14

When component 14 is energized, normally open relay 1 contacts will close, connecting circuit C14 (+12V source) with circuit C18 that feeds component 10 (polarity indicator) red warning light and buzzer in the instrument panel to warn the technician of the incorrect connection of the mobile charging system to the vehicle battery. Circuit C18 also feeds component 15 (Normally Closed) relay 2 contacts that connect to circuit C21.

Component 15 may be de-energized during a reverse polarity condition and may act as an interrupt during boost cycle. When circuit C21 has +12 Volts it will energize component 17 (Normally Closed) Contactor resulting in a circuit break between circuit C16 vehicle battery and circuit C20 that controls the mobile charging system output, thus providing protection to amp meter 8 and fuse box 4 and other internal mobile charging system components. In addition, it also prevents the mobile charging system boost and charge functions from causing electrical damage to the weak or discharged vehicle battery and electrical system by isolating the same from the mobile charging system internal power source.

It will be appreciated that elements or components shown with any embodiment herein are merely exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A mobile charging system, comprising:
a. a housing;
b. a rechargeable source of energy, the rechargeable source of energy comprising a multi-cell battery arrangement;
c. a circuit to detect an incorrect placement of charging cables with respect to a battery to be charged;
d. an indicator configured to detect proper placement of charging cables with respect to the battery to be charged;
e. a jumpstart and boost circuit configured to, in a jumpstart and boost mode, deliver a direct high current connection between a subset of the cells in the rechargeable source of energy and the battery to be jumpstarted; and
f. a charging circuit configured to, in a charging mode, deliver a high current from all of the cells in the rechargeable source of energy, the cells connected in parallel.

2. The system of claim 1, configured to charge a 12 V battery system, where the system does not require an external power source such as 120 Volts AC.

3. The system of claim 1, further comprising an internal power source.

4. The system of claim 1, wherein the system is configured such that, when connected in reverse polarity, an indicator alerts or alarms the user, even at very low voltage.

5. The system of claim 1, wherein the system is configured to automatically disable all electrical connections between the mobile charging system and a discharged battery, whereby both sources are protected.

6. The system of claim 1, further comprising at least one wheel assembly coupled to the housing and configured to allow the housing to be moved in a wheeled fashion from one location to another.

7. The system of claim 6, wherein the wheel assembly is a powered wheel assembly, and wherein the wheel assembly is powered by the rechargeable source of energy.

8. The system of claim 1, wherein the charging circuit charges through at least one DC-DC converter.
